(19) United States
(12) Patent Application Publication
(10) Pub. No.: US 2026/0119176 A1
(43) Pub. Date: Apr. 30, 2026

(54) Vector Scatter and Gather with Single Memory Access

(71) Applicant: Akeana, Inc., Santa Clara, CA (US)

(72) Inventors: Hai Ngoc NGUYEN, Redwood City, CA (US); Rabin SUGUMAR, Sunnyvale, CA (US)

(73) Assignee: Akeana, Inc., Santa Clara, CA (US)

(21) Appl. No.: 18/926,421

(22) Filed: Oct. 25, 2024

Related U.S. Application Data
(60) Provisional application No. 63/545,961, filed on Oct. 27, 2023.
(60) Provisional application No. 63/546,769, filed on Nov. 1, 2023.
(60) Provisional application No. 63/547,404, filed on Nov. 6, 2023.
(60) Provisional application No. 63/547,574, filed on Nov. 7, 2023.
(60) Provisional application No. 63/602,514, filed on Nov. 24, 2023.
(60) Provisional application No. 63/605,620, filed on Dec. 4, 2023.
(60) Provisional application No. 63/556,944, filed on Feb. 23, 2024.
(60) Provisional application No. 63/556,951, filed on Feb. 23, 2024.
(60) Provisional application No. 63/563,102, filed on Mar. 8, 2024.
(60) Provisional application No. 63/563,492, filed on Mar. 11, 2024.
(60) Provisional application No. 63/564,529, filed on Mar. 13, 2024.
(60) Provisional application No. 63/570,281, filed on Mar. 27, 2024.
(60) Provisional application No. 63/640,921, filed on May 1, 2024.
(60) Provisional application No. 63/641,045, filed on May 1, 2024.
(60) Provisional application No. 63/653,402, filed on May 30, 2024.
(60) Provisional application No. 63/679,192, filed on Aug. 5, 2024.
(60) Provisional application No. 63/679,685, filed on Aug. 6, 2024.
(60) Provisional application No. 63/687,795, filed on Aug. 28, 2024.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.

(51) Int. Cl. G06F 9/30

(52) U.S. Cl. CPC G06F 9/30098; G06F 9/30036

(57) ABSTRACT

Disclosed embodiments provide techniques for improved performance in processing vector instructions. A processor core is accessed. The processor core is coupled to a memory hierarchy, and the processor core includes one or more vector execution units (VUs), and one or more load store units (LSUs). The processor core includes a vector register file (VRF). The VRF includes multiple vector registers, and each vector register includes multiple vector elements. Vector elements that have a source or destination in contiguous memory are identified. Load store units (LSUs) take advantage of the contiguous memory condition by executing a vector load or vector store operation as a single memory access, requiring a reduced number of clock cycles. The single memory access satisfies each memory operation for each vector element within the vector register file.

### RELATED APPLICATIONS

This application claims the benefit of U.S. provisional patent applications “Vector Scatter And Gather With Single Memory Access” Ser. No. 63/545,961, filed Oct. 27, 2023, “Pipeline Optimization With Variable Latency Execution” Ser. No. 63/546,769, filed Nov. 1, 2023, “Cache Evict Duplication Management” Ser. No. 63/547,404, filed Nov. 6, 2023, “Multi-Cast Snoop Vectors Within A Mesh Topology” Ser. No. 63/547,574, filed Nov. 7, 2023, “Optimized Snoop Multi-Cast With Mesh Regions” Ser. No. 63/602,514, filed Nov. 24, 2023, “Cache Snoop Replay Management” Ser. No. 63/605,620, filed Dec. 4, 2023, “Processing Cache Evictions In A Directory Snoop Filter With ECAM” Ser. No. 63/556,944, filed Feb. 23, 2024, “System Time Clock Synchronization On An SOC With LSB Sampling” Ser. No. 63/556,951, filed Feb. 23, 2024, “Malicious Code Detection Based On Code Profiles Generated By External Agents” Ser. No. 63/563,102, filed Mar. 8, 2024, “Processor Error Detection With Assertion Registers” Ser. No. 63/563,492, filed Mar. 11, 2024, “Starvation Avoidance In An Out-Of-Order Processor” Ser. No. 63/564,529, filed Mar. 13, 2024, “Vector Operation Sequencing For Exception Handling” Ser. No. 63/570,281, filed Mar. 27, 2024, “Vector Length Determination For Fault-Only-First Loads With Out-Of-Order Micro-Operations” Ser. No. 63/640,921, filed May 1, 2024, “Circular Queue Management With Nondestructive Speculative Reads” Ser. No. 63/641,045, filed May 1, 2024, “Direct Data Transfer With Cache Line Owner Assignment” Ser. No. 63/653,402, filed May 30, 2024, “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, and “Non-Blocking Unit Stride Vector Instruction Dispatch With Micro-Operations” Ser. No. 63/702,192, filed Oct. 2, 2024.

Each of the foregoing applications is hereby incorporated by reference in its entirety.

### FIELD OF ART

This application relates generally to computer processors and more particularly to vector scatter and gather with single memory access.

### BACKGROUND

Despite the advantages that modern processors possess, the need for even greater processor performance is likely to continue in the future. As technology advances, the computational demands of applications and services continue to grow. Emerging technologies, such as artificial intelligence, virtual reality, and augmented reality, rely on complex algorithms and massive datasets which require substantial processing power. Future applications will likely demand even more computational resources to deliver enhanced user experiences and functionality. The gaming industry and media consumption trends continue to drive the need for more powerful processors. Higher resolution graphics, 3D rendering, and 4K/8K video content require increased processing performance for smooth and immersive experiences. Scientific analysis, climate modeling, and complex simulations in various fields rely on powerful processors to conduct research and make scientific advancements. These applications benefit from faster and more capable processors. As cybersecurity threats evolve, the need for high-performance processors to encrypt and decrypt data rapidly increases. This is essential for maintaining data privacy and security in an interconnected world. Furthermore, with the rise of edge computing, where data is processed closer to where it is generated, processors need to be more powerful to handle real-time processing at the edge. Edge applications, such as IoT devices and smart infrastructure, will drive the need for higher-performance processors. As long as technology continues to advance and new applications emerge, the need for even more powerful processor performance will remain a driving force in the technology industry.

Integrated circuits (ICs) such as processors may be designed using a Hardware Description Language (HDL). Examples of such languages can include Verilog, VHDL, etc. HDLs enable the description of behavioral, register transfer, gate, and switch level logic. This provides designers with the ability to define levels in detail. Behavioral level logic allows for a set of instructions executed sequentially, while register transfer level logic allows for the transfer of data between registers, driven by an explicit clock and gate level logic. The HDL can be used to create text models that describe or express logic circuits. The models can be processed by a synthesis program, followed by a simulation program to test the logic design. Part of the process may include Register Level Transfer (RTL) abstractions that define the synthesizable data that is fed into a logic synthesis tool, which in turn creates the gate-level abstraction of the design that is used for downstream implementation operations. In addition, after manufacture and before product shipment, processors must somehow be tested to ensure functionality, performance, quality, compliance, and so on. However, regardless of how processors are designed and tested, they must provide high performance to meet the growing needs of technological advances and industry promises.

### SUMMARY

Vector-based operations are essential in various computer software applications for their efficiency in handling data and performing mathematical and graphical tasks. Graphic design applications use vector graphics to create scalable and high-quality images. Vector graphics describe images in terms of lines, curves, and shapes, making them ideal for logos, icons, and illustrations. Computer-Aided Design (CAD) software uses vectors for precise two-dimensional (2D) and three-dimensional (3D) modeling. Vectors are used to define shapes, dimensions, and geometry in engineering and architectural designs. GIS (Geographic Information Systems) software utilizes vectors to represent geographical data. Vectors are used to define boundaries, routes, and geographic features in maps and spatial analysis. Software used in mathematics and scientific research often employs vector operations for mathematical modeling, simulations, and data analysis. Moreover, in programming languages like Python, R, and MATLAB, libraries like NumPy and SciPy facilitate vector operations for numerical computing, data analysis, and scientific computation. Furthermore, machine learning libraries such as TensorFlow and PyTorch use vectors extensively to represent data and model parameters for tasks like deep learning and statistical analysis.

Disclosed embodiments provide techniques for improved performance in processing vector instructions. A processor core is accessed. The processor core is coupled to a memory hierarchy, and the processor core includes one or more vector execution units (VUs), and one or more load store units (LSUs). The processor core includes a vector register file (VRF), the VRF includes multiple vector registers, and each vector register includes multiple vector elements. Vector elements that have a source or destination in contiguous memory are identified. Load store units (LSUs) take advantage of the contiguous memory condition by executing a vector load or vector store operation as a single memory access, requiring a reduced number of clock cycles. The single memory access satisfies each memory operation for each vector element within the vector register file.

A processor-implemented method for sharing data is disclosed comprising: accessing a processor core, wherein the processor core is coupled to a memory hierarchy, wherein the processor core includes one or more vector execution units (VUs) and one or more load store units (LSUs), wherein the processor core includes a vector register file (VRF), wherein the VRF includes a plurality of vector registers, and wherein each vector register in the plurality of vector registers comprises a plurality of vector elements; receiving, by an LSU within the one or more LSUs, a vector memory instruction, wherein the vector memory instruction includes a first vector register, a plurality of vector element memory operations, and a plurality of memory addresses, and wherein each vector element within the first vector register is associated with a memory operation in the plurality of vector element memory operations and a memory address in the plurality of memory addresses; detecting, by the LSU, that the plurality of memory addresses comprises contiguous memory locations within the memory hierarchy; and performing a single memory access, by the LSU, wherein the single memory access satisfies each memory operation for each vector element within the vector register file. In embodiments, the vector memory instruction includes an indexed stride addressing mode. In embodiments, the detecting further comprises reading, for each vector element within the first vector register, an index value, wherein each index value is stored in a second vector register. Some embodiments comprise calculating, for each vector element within the first vector register, an element address check value, wherein each element address check value comprises a vector element width multiplied by a vector element number.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for vector scatter and gather with single memory access.

FIG. 2 is a flow diagram for detecting contiguous addresses.

FIG. 3 is a block diagram illustrating a multicore processor.

FIG. 4 is a block diagram for a pipeline.

FIG. 5 shows a table of vector lengths and associated vector element widths.

FIG. 6 is an example of a constant stride addressing mode.

FIG. 7 is an example of adjacent addresses with constant stride addressing.

FIG. 8 is an example of an indexed stride addressing mode.

FIG. 9 is an example of adjacent addresses with indexed stride addressing.

FIG. 10 is a system diagram for vector scatter and gather with single memory access.

### DETAILED DESCRIPTION

Processing of vector memory instructions in a System on a Chip (SoC) can impact the performance and efficiency of the chip and the devices it powers. Vector memory instruction processing can result in lower computational throughput, which can be detrimental for applications that require high-speed data processing such as graphics rendering, scientific simulations, and artificial intelligence tasks. Moreover, prolonged execution of vector memory instructions can lead to higher power consumption, as the processor may need to operate at higher clock frequencies for longer durations. This can negatively impact battery life in portable devices and increase overall power consumption. Furthermore, vector memory instructions can cause a memory bandwidth bottleneck, resulting in data starvation as the processor must wait for memory accesses to complete, further reducing the speed of execution.

The number of bits in a register in a processor can vary widely depending on the specific processor architecture and design, and processors can include a variety of registers of varying size. In some embedded and microcontroller architectures, registers may be 8 bits wide. 32-bit registers are commonly found in many general-purpose microprocessors and microcontrollers. 32-bit registers are used in a wide range of computing devices, from desktop computers to embedded systems. 64-bit registers are used in 64-bit processors, which are common in modern desktop and server computers. These registers can store 64 bits of data, allowing for larger data manipulation and memory addressing capabilities. In processors with vector processing capabilities, such as GPUs and vector processing units, vector registers can be much wider, typically ranging from 128 bits to 512 bits or more. Vector registers are used to store and process multiple data elements simultaneously.

As vector operations are used in many important fields, increased performance for vector operations can provide significant benefits for a variety of applications that use vector operations. A processor can require multiple cycles to load and store vector operations. Vector operations can be a class of SIMD instruction, which stands for Single Instruction, Multiple Data instruction. With load operations, multiple operands are fetched from various memory locations, and each operand is loaded into a portion of a vector register. Similarly, with a store instruction, multiple vector elements are written from a vector register, where each of the multiple vector elements is written to a different memory location. The loading and storing of vector data can require multiple clock cycles to complete, which can adversely affect performance.

Disclosed embodiments address the aforementioned issues by providing techniques for improved performance in processing vector memory instructions. More particularly, disclosed embodiments identify vector elements having a source or destination in contiguous memory, and take advantage of the contiguous memory condition by executing a vector load or vector store operation in a reduced number of clock cycles. The vector store instruction stores vector elements in memory. This can be referred to as a vector scatter operation. In general, the memory locations need not be contiguous. However, when the memory locations for all the vector elements in a register are contiguous, then disclosed embodiments identify and take advantage of the contiguous arrangement for improved performance for vector scatter operations. Similarly, the vector load instruction loads vector elements from memory into a vector register. This can be referred to as a vector gather operation. Similar to the aforementioned scatter operation, in general, the memory locations need not be contiguous. However, when the memory locations for all the vector elements in a register are contiguous, then disclosed embodiments identify and take advantage of the contiguous arrangement for improved performance for vector gather operations. Since vector scatter and vector gather are fundamental operations for any vector-based application, any time savings in these operations can have a significant impact on overall performance.

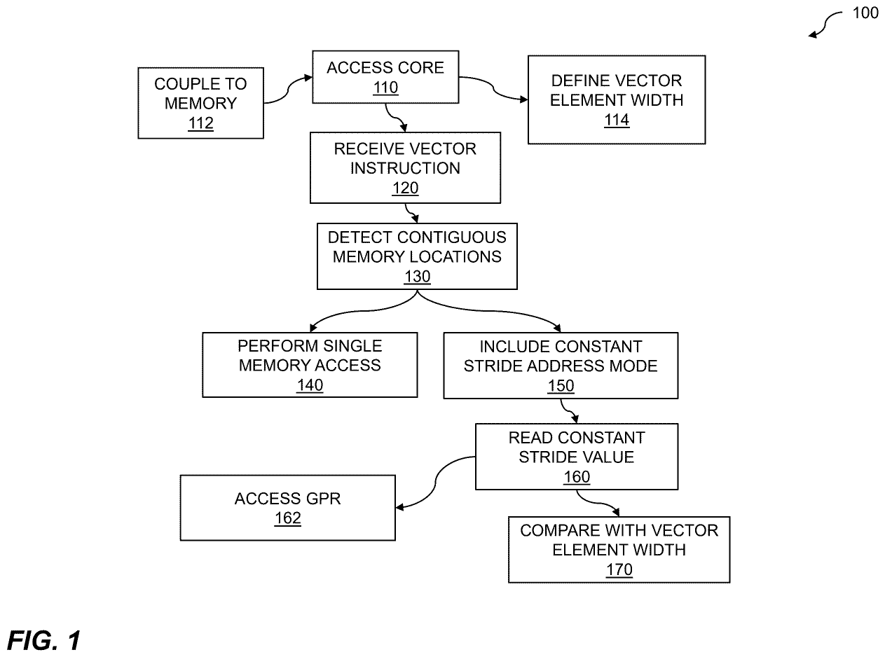

FIG. 1 is a flow diagram for vector scatter and gather with single memory access. The flow 100 starts with accessing a processor core 110. The core can include an ARM core, RISC-V core, MIPS core, or other general-purpose core. In one or more embodiments, the core can include a graphics processing unit (GPU) core, machine learning core, or other suitable core type. The flow 100 further includes coupling the processor core to memory 112. More particularly, the flow 100 can include coupling the processor core to a memory hierarchy. The memory hierarchy can include multiple cache levels, along with a main memory and a memory management unit (MMU) for maintaining cache coherency. The MMU can handle virtual memory management, address translation, caching, page table management, and so on.

The flow 100 can include defining a vector element width 114. In one or more embodiments, the vector element width is 8 bits, 16 bits, 32 bits, or 64 bits. In some embodiments, other vector element widths may be used. In embodiments, the processor core includes one or more vector execution units (VUs) and one or more load store units (LSUs), wherein the processor core includes a vector register file (VRF), where the VRF includes a plurality of vector registers, and where each vector register in the plurality of vector registers comprises a plurality of vector elements. The VUs can perform operations on one or more vectors. These operations can include vectorized addition and subtraction operations, where each element of one vector is added to or subtracted from the corresponding element in another vector. The operations can include multiplication and division operations that are performed element-wise on vectors. Additionally, the operations can include dot product, cross product, comparison operations, mathematical functions, transposition, shuffling and permutation, and so on. The LSUs can perform gather and scatter operations. In general, these operations are used to access memory locations in a vectorized manner. Gather operations fetch elements from scattered memory locations, and scatter operations store elements back to those locations. Disclosed embodiments can take advantage of the special case of contiguous scatter and gather, and can process that condition differently than the general case to achieve improved performance with vector operations. Contiguous memory locations refer to a block of memory addresses that are physically adjacent to each other in the computer's memory hierarchy, without any gaps or other data structures in between. These addresses can be consecutive and can follow each other in a linear fashion.

Contiguous memory is often used for various data structures, such as arrays, lists, and blocks of memory allocated for a specific purpose. Moreover, contiguous memory can improve cache efficiency because data located close together in memory can be loaded into cache lines more effectively. Additionally, compilers can take several steps to promote the use of contiguous memory, which can help improve data access efficiency and reduce memory fragmentation. These steps involve memory layout optimizations and various techniques to ensure that data is stored in a more contiguous manner. For example, compilers can align data structures and variables to memory boundaries to ensure that they start at addresses which are multiples of the required alignment. This alignment facilitates efficient memory access and can help maintain contiguity for data elements. For arrays, compilers can ensure that elements are stored in a contiguous manner. This can include optimizing the order of elements within arrays or ensuring that arrays are allocated in a way that minimizes fragmentation. Thus, the techniques employed by compilers can increase the likelihood of data structures that are stored in contiguous memory, including vector data structures, which can benefit from the improvements provided by disclosed embodiments. In one or more embodiments, a compiler produces vectorized code that includes contiguous data to leverage the improved performance provided by disclosed embodiments.

The flow 100 further includes receiving a vector instruction 120. The vector instruction can include a vector memory instruction. In embodiments, the vector memory instruction is a vector gather instruction. In further embodiments, the vector memory instruction is a vector scatter instruction. Vector instructions are a key feature in modern processors, designed to perform operations on multiple data elements simultaneously, which can greatly enhance the performance of various applications, particularly those involving data-intensive tasks. The vector instructions can include mathematical operations such as matrix addition, subtraction, multiplication, and division, as well as other vector operations to support a wide range of applications, including scientific computing, machine learning, graphics rendering, and multimedia processing. The availability and performance of vector instructions can significantly impact the efficiency of these applications, making them an essential aspect of modern processor design and performance optimization. Embodiments can include receiving, by an LSU within the one or more LSUs, a vector memory instruction, where the vector memory instruction includes a first vector register, a plurality of vector element memory operations, and a plurality of memory addresses, and where each vector element within the first vector register is associated with a memory operation in the plurality of vector element memory operations and a memory address in the plurality of memory addresses.

The flow 100 further includes detecting contiguous memory locations 130. The detecting can include obtaining a stride value. The stride value can be a constant stride value. Embodiments can include reading a constant stride value from a general-purpose register (GPR) within a general-purpose register file. Memory stride, in the context of computer programming and memory access, refers to the fixed or variable offset between successive memory locations accessed as a program iterates through data. Memory stride can be used to describe the pattern or sequence in which data elements are accessed in memory. In a constant stride, the offset between successive memory locations is constant. For example, when accessing an array of integers, the stride might be 4 bytes on a 32-bit system because each integer occupies 4 bytes in memory. Vector elements can be stored in, and retrieved from, memory via scatter and gather operations. When vector elements are accessed sequentially with a constant stride, embodiments can perform a more efficient transfer of vector elements between registers and memory locations, thereby improving overall processor performance. In general, an address element memory location for a constant stride can be described as: rs1+ (element number*rs2), where rs1 contains the base address and rs2 contains the constant stride value (e.g., as a number of bytes, words, or other suitable element size). In one or more embodiments, both rs1 and rs2 are operands that are accessible from an integer register file.

A memory stride can be denoted as an indexed stride. In an indexed stride, each vector element is offset by an element index. An indexed stride can be used to access vector elements in memory. In general, an address element memory location for an indexed stride can be described as: rs1+vs2[element index], where rs1 is an operand stored in an integer register file and contains the base address, and vs2 is an operand from a vector register file and contains the index values of all elements of the vector. In the scenario where the index value is equal to element width*element number, the elements are placed contiguously in memory. For example, contiguous memory occurs in a situation where the element width is 2 bytes (16 bits) and index0=0, index 1=2, index2=4, and so on, with a general pattern of index n=2n. In disclosed embodiments, for both a constant stride addressing mode and an indexed stride addressing mode, a contiguous memory allocation for vector elements can be detected by examining the values of rs1, rs2, vs2, and/or the element index, depending on the addressing mode in use. Embodiments can include detecting, by the LSU, that the plurality of memory addresses comprises contiguous memory locations within the memory hierarchy.

The flow 100 can include performing a single memory access 140. The single memory access can occur when contiguous memory is detected as a source or destination for vector elements. In disclosed embodiments, when the source/destination for vector elements is non-contiguous, vector gather and vector scatter operations may perform reading/writing of vector elements over multiple clock cycles. The number of clock cycles can be dependent on the number of vector elements and the available resources within the processor. However, when the source/destination for vector elements is contiguous, vector gather and vector scatter operations can utilize an accelerated gather/scatter mode, performing reading/writing of vector elements to/from memory in a single clock cycle. Thus, the accelerated gather/scatter mode can include performing a single memory access to transfer all the vector elements within a vector register to/from memory. In embodiments, the single memory access comprises 64 bits, 128 bits, 256 bits, or 512 bits. Accordingly, disclosed embodiments can achieve a performance improvement by automatically switching to the accelerated mode in response to detecting contiguous memory for vector scatter/gather operations. Similarly, disclosed embodiments can automatically switch to a conventional gather/scatter mode to accommodate reading/writing of vector elements to/from non-contiguous memory when that scenario is encountered. In this way, disclosed embodiments exploit the contiguous memory condition for improved processor performance where possible. Embodiments can include performing a single memory access, by the LSU, wherein the single memory access satisfies each memory operation for each vector element within the vector register file.

The flow 100 can include constant address stride mode 150. The special case where the constant stride (e.g., in number of bytes) is equivalent to the width of a vector element implies that the vector elements are placed contiguously in memory. In embodiments, the constant stride value is accessible via a general-purpose register. In embodiments, the general-purpose registers can contain a wide range of information, including memory configuration details. The memory configuration details can include memory addresses, indicating the location in memory where data should be read from or written to. These addresses can be used to access variables, data structures, or instructions in memory. The memory configuration details can include a base address register to support memory addressing modes that indicate a starting point or base location in memory, such as for addressing elements of data structures or arrays. The memory configuration details can include offsets and/or indices for supporting memory addressing. When the offsets/indices are combined with a base address, it can enable the processor to access specific elements within arrays or data structures.

The flow 100 can continue with reading a constant stride value 160. The constant stride value may be obtained from a general-purpose register that contains memory configuration information. The flow 100 can include accessing a general-purpose register (GPR) 162. The constant stride value can be stored in a GPR. The flow 100 can include comparing the constant stride value with the vector element width 170. The result of the comparing can be used in detecting the condition of contiguous memory locations, which in turn is used as a criterion for accelerated vector gather/scatter operations which can accomplish transfer of vector elements to/from memory in a single clock cycle.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

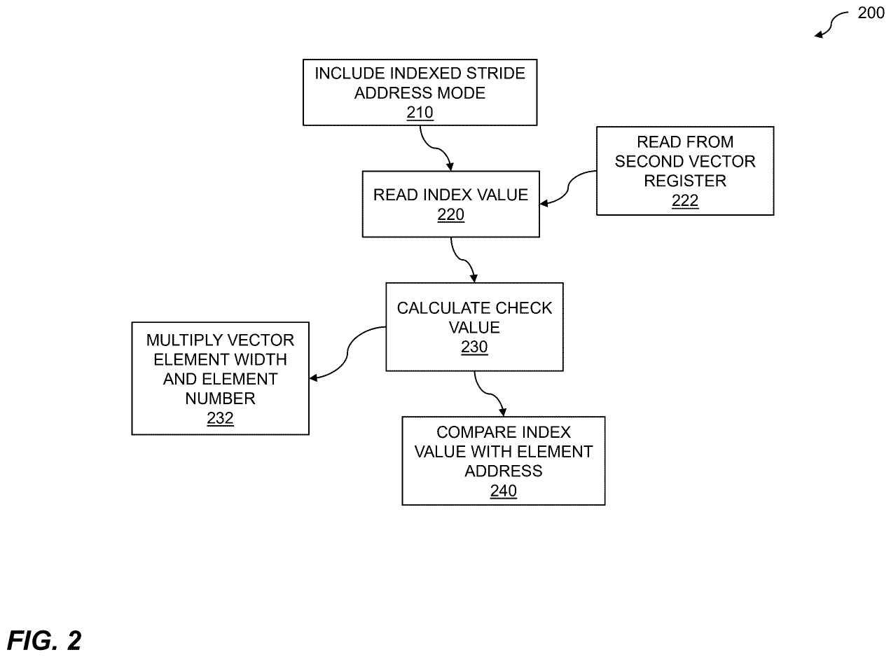

FIG. 2 is a flow diagram for detecting contiguous addresses. The flow 200 starts with including an indexed stride address mode 210. Indexed addressing modes are common and efficient ways to process arrays and data structures in computer programming. More particularly, indexed addressing modes provide advantages for vector element processing, especially when operating on arrays of data that include multiple vector elements. Moreover, indexed addressing modes enable efficient random access to vector elements using an index variable. The indexed stride address mode can enable access of any element of a vector without the need to traverse the entire vector sequentially, and thus, enables efficient processing of vector operations/instructions. The flow 200 includes reading an index value 220. The index value can be read from a vector register that stores an index value for each vector element of a vector. In embodiments, the vector elements can be stored in a first vector register, and the corresponding index values for each of the vector elements that are stored in the first vector register can be stored in a second vector register. Thus, the flow 200 can include reading information from a second vector register 222. In embodiments, the information comprises a vector index corresponding to a vector element in another vector register.

The flow 200 further includes calculating a check value 230. In embodiments, for indexed stride addressing, each vector element has a corresponding element address check value. The check value can be computed as a product of a vector element width and the corresponding index value. In embodiments, the vector element width is specified in bits. The flow 200 can include multiplying a vector element width and element number 232. The element number can represent the ordinal position of an individual vector element within a vector. As an example, with a vector element width of 8 bits, and an index value of 2 (corresponding to the third element of a vector), the element address check value is computed as 8*2=16, indicating that the vector element corresponding to index 2 starts at bit 16 of a vector register or memory location. Similarly, for an index value of 3 (corresponding to the following element of a vector), the element address check value is computed as 8*3=24, indicating that the vector element corresponding to index 3 starts at bit 24 of a vector register or memory location. Embodiments can include performing a comparison to confirm that the bit position of the vector element corresponding to index 2, plus the vector element width, is equivalent to the starting bit position for vector element 3, indicating a contiguous memory condition. The flow 200 can include comparing the index value with the element address 240. More generally, in one or more embodiments, the comparison can be performed as S*Vi+S=V(i+1)*S, where S is the vector element size in bits, Vi is the index value for vector element i, and V(i+1) is the index value for vector element i+1. When this condition is satisfied for elements 0 through (N−1), where N is the number of elements in the vector, a contiguous memory condition is detected. In response to detecting the contiguous memory condition, disclosed embodiments can automatically use the accelerated vector scatter/gather operations. Thus, embodiments can include calculating, for each vector element within the first vector register, an element address check value, wherein each element address check value comprises a vector element width multiplied by a vector element number. Disclosed embodiments support accelerated vector gather and vector scatter operations with an indexed stride addressing mode. The indexed stride addressing mode is useful for various vector operations, including those supporting linear algebra such as vector addition and subtraction, determinant computations, matrix transposition, eigenvalue computation, and so on. As these operations have many uses in science, engineering, data processing, and the like, disclosed embodiments are useful for improving performance in a wide variety of applications. Embodiments can include comparing the constant stride value with a vector element width. In embodiments, the constant stride value is equal to the vector element width.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

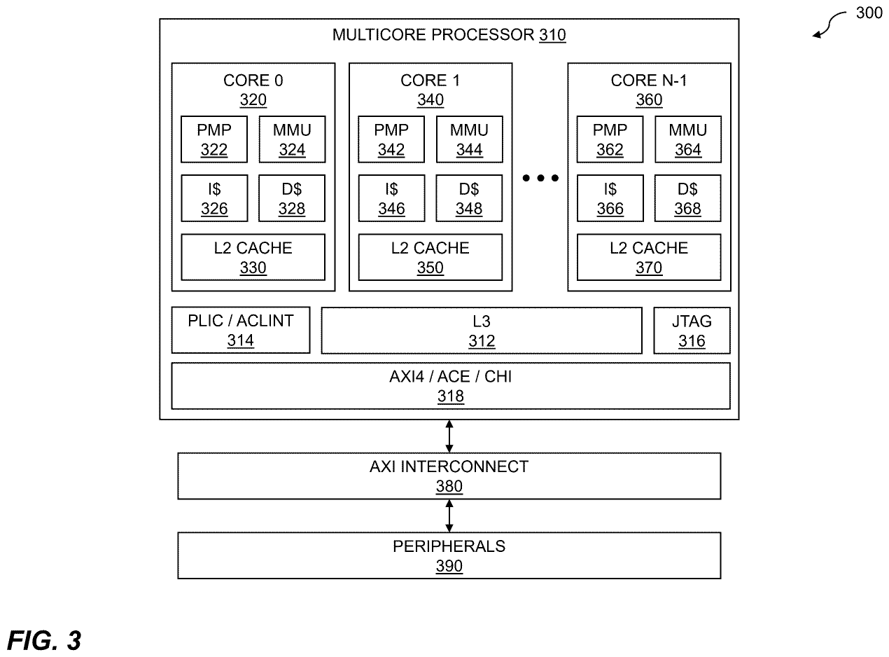

FIG. 3 is a block diagram illustrating a multicore processor. The processor, such as a RISC-V™ processor, ARM processor, or other suitable processor type, can include a variety of elements. The elements can include processor cores, one or more caches, memory protection and management units, local storage, and so on. In embodiments, the processor core executes one or more instructions out of order. The elements of the multicore processor can further include one or more of a private cache, a test interface such as a joint test action group (JTAG) test interface, one or more interfaces to a network such as a network-on-chip, shared memory, peripherals, and the like. The multicore processor is enabled by coherency management using distributed snoop. Snoop requests are ordered in a two-dimensional matrix, wherein the two-dimensional matrix is extensible along each axis of the two-dimensional matrix. Snoop responses are mapped to a first-in first-out (FIFO) mapping queue, wherein each snoop response corresponds to a snoop request, and wherein each processor core of the plurality of processor cores is coupled to at least one FIFO mapping queue. A memory access operation is completed, based on a comparison of the snoop requests and the snoop responses.

In the block diagram 300, a multicore processor 310 can comprise two or more processors, where the two or more processors can include homogeneous processors, heterogeneous processors, etc. In the block diagram, the multicore processor can include N processor cores such as core 0 320, core 1 340, core N−1 360, and so on. Each processor can comprise one or more elements. In embodiments, each core, including cores 0 through core N−1, can include a physical memory protection (PMP) element, such as PMP 322 for core 0; PMP 342 for core 1, and PMP 362 for core N−1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 324 for core 0, MMU 344 for core 1, and MMU 364 for core N−1. The memory management units can translate virtual addresses used by software running on the cores to physical memory addresses with caches, the shared memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$ 326 and a data cache D$ 328 associated with core 0; an instruction cache I$ 346 and a data cache D$ 348 associated with core 1; and an instruction cache I$ 366 and a data cache D$ 368 associated with core N−1. In addition to the level 1 instruction and data caches, each core can include a level 2 (L2) cache. The level 2 caches can include L2 cache 330 associated with core 0; L2 cache 350 associated with core 1; and L2 cache 370 associated with core N−1. The cores associated with the multicore processor 310 can include further components or elements. The further elements can include a level 3 (L3) cache 312. The level 3 cache, which can be larger than the level 1 instruction and data caches, and the level 2 caches associated with each core, can be shared among all of the cores. The further elements can be shared among the cores. In embodiments, the further elements can include a platform level interrupt controller (PLIC) 314. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces such as an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In embodiments, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

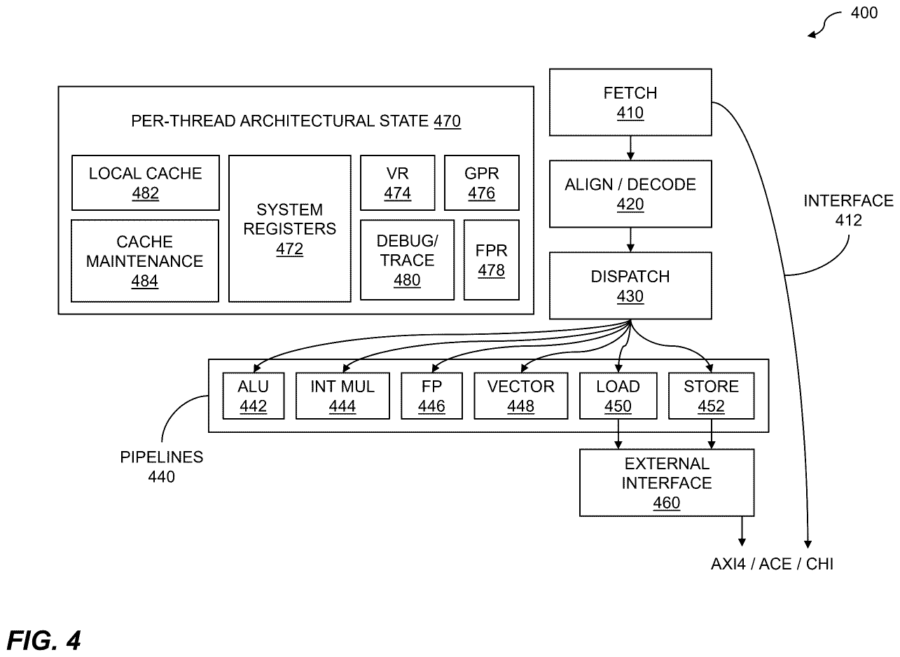

FIG. 4 is a block diagram for a pipeline. The use of one or more pipelines associated with a processor architecture can greatly enhance processing throughput. The processor architecture can be associated with one or more processor cores. The processing throughput can be increased because multiple operations can be executed in parallel.

The blocks within the block diagram can be configurable in order to provide varying processing levels. The varying processing levels can be based on processing speed, bit lengths, and so on. The block diagram 400 can include a fetch block 410. The fetch block 410 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decode packets. The decode packets can be used in the pipeline to manage execution of operations. The system block diagram 400 can include a dispatch block 430. The dispatch block can receive decoded instruction packets from the align and decode block. The decoded instruction packets can be used to control a pipeline 440, where the pipeline can include an in-order pipeline, an out-of-order (OoO) pipeline, etc. In embodiments, the processor core executes one or more instructions out of order. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipelines that can include load pipelines 450 and store pipelines 452. The load pipelines and the store pipelines can access storage such as the common memory using an external interface 460. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, the plurality of processors can be configured to support multi-threading. The system block diagram can include a per-thread architectural state block 470. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VR) 474. The vector registers can be grouped in a vector register file and can be used for vector operations. In embodiments, the width of the vector register file is 512 bits. Additional registers, such as general-purpose registers (GPRs) 476 and floating-point registers (FPRs) 478, can be included. These registers can be used for general purpose (e.g., integer) operations and floating-point operations, respectively. The per-thread architectural state can include a debug and trace block 480. The debug and trace block can enable debug and trace operations to support code development, troubleshooting, and so on. In embodiments, an external debugger can communicate with a processor through a debugging interface such as a joint test action group (JTAG) interface. The per-thread architectural state can include a local cache state 482. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, and maintenance complete states, etc.

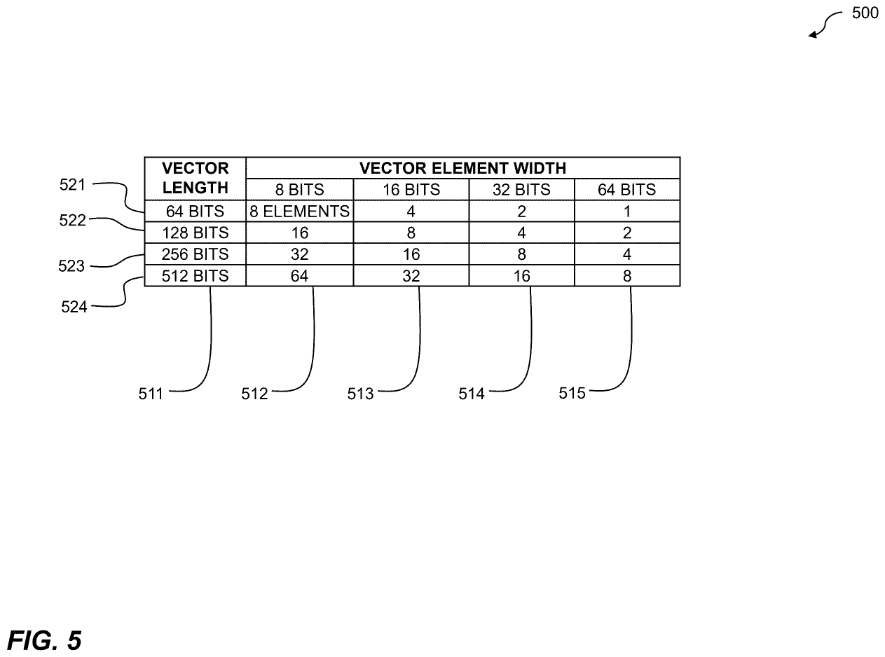

FIG. 5 shows a table of vector lengths and associated vector element widths. Table 500 includes five columns, indicated as 511, 512, 513, 514, and 515. Table 500 includes four rows, indicated as 521, 522, 523, and 524. The table 500 indicates the number of vector elements within a vector register as a function of vector register length and vector element width. Column 511 includes various vector lengths, corresponding to the size of a vector register within a processor of disclosed embodiments. At column 511 row 521, a length of 64 bits is indicated; at column 511 row 522, a length of 128 bits is indicated; at column 511 row 523, a length of 256 bits is indicated; and at column 511 row 524, a length of 512 bits is indicated. Other lengths are possible in disclosed embodiments. At column 512, the number of vector elements is shown for each of the lengths in column 511 when the vector element size is 8 bits. At column 512, row 521, a value of 8 elements is indicated; at column 512, row 522, a value of 16 elements is indicated; at column 512, row 523, a value of 32 elements is indicated; and at column 512, row 524, a value of 64 elements is indicated. At column 513, the number of vector elements is shown for each of the lengths in column 511 when the vector element size is 16 bits. At column 513, row 521, a value of 4 elements is indicated; at column 513, row 522, a value of 8 elements is indicated; at column 513, row 523, a value of 16 elements is indicated; and at column 513, row 524, a value of 32 elements is indicated. At column 514, the number of vector elements is shown for each of the lengths in column 511 when the vector element size is 32 bits. At column 514, row 521, a value of 2 elements is indicated; at column 514, row 522, a value of 4 elements is indicated; at column 514, row 523, a value of 8 elements is indicated; and at column 514, row 524, a value of 16 elements is indicated. At column 515, the number of vector elements is shown for each of the lengths in column 511 when the vector element size is 64 bits. At column 515, row 521, a value of 1 element is indicated; at column 515, row 522, a value of 2 elements is indicated; at column 515, row 523, a value of 4 elements is indicated; and at column 515, row 524, a value of 8 elements is indicated. Other vector register lengths and vector element widths are possible in disclosed embodiments. Embodiments can include defining a vector element width. In embodiments, the defining is accomplished by a control register. In embodiments, the defining is accomplished by the vector memory instruction.

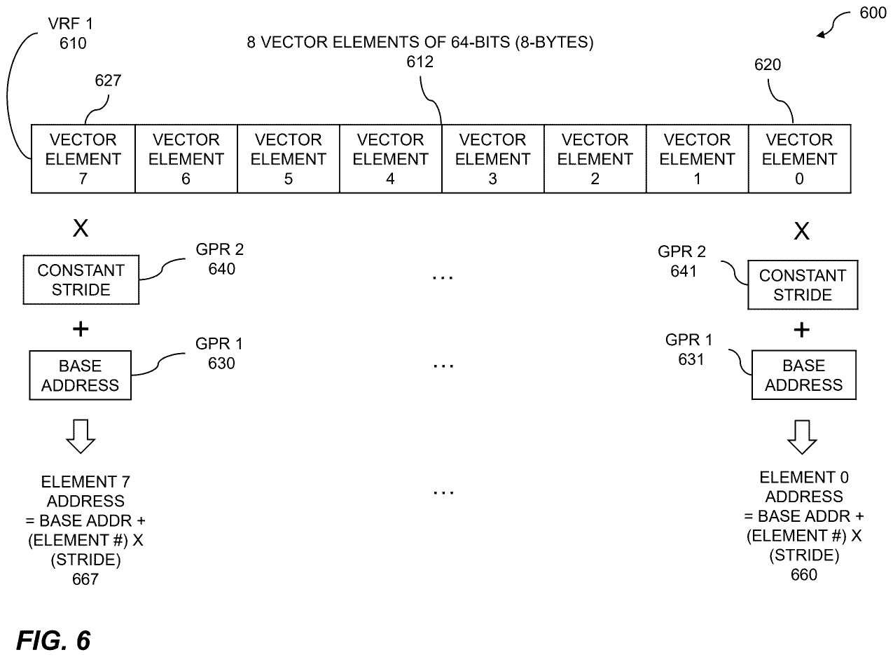

FIG. 6 is an example of a constant stride addressing mode. The example 600 shows a first vector register 610, denoted as VRF 1, a first general-purpose register 630, denoted as GPR 1, and a second general-purpose register 640, indicated as GPR 2. As shown in the example, the length of vector register 610 is eight bytes, as indicated by the group of vector elements 612, starting from vector element 0 at 620, and continuing to vector element 7, as indicated at 627. In embodiments, the plurality of vector elements within the first vector register comprises a number of vector elements equal to dividing a vector length by the vector element width. In embodiments, the plurality of vector elements within the first vector register comprises 8 bits, 16 bits, 32 bits, or 64 bits. In embodiments, the first vector register comprises 64 bits, 128 bits, 256 bits, or 512 bits. In the example 600, each vector element is 64 bits, and with eight elements, the length for vector register VRF 1 is 512 bits. Each vector element from the group of vector elements has a corresponding location computed as a function of stride and a base address. The location can be computed by multiplying the element number times the stride, and adding the value to the base address. As an example, with a base address 631 of 0x10000000, and a constant stride 641 of 8 bytes (64 bits), the element 0 address 660 corresponding to vector element 0 can be computed as: 0x10000000+8*0=0x10000000. Similarly, the element 7 address 667 corresponding to vector element 7 can be computed as 0x10000000+8*7=0x10000038, and so on. In disclosed embodiments, adjacent addresses are checked to determine if a contiguous memory condition exists. In response to detecting a contiguous memory condition, disclosed embodiments automatically use accelerated vector scatter and/or vector gather operations in those cases.

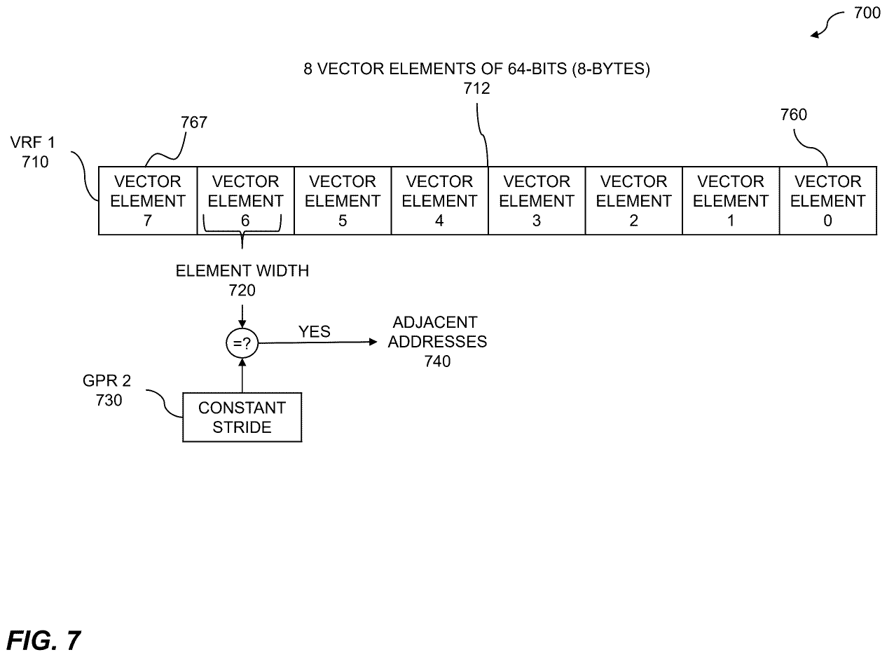

FIG. 7 is an example of adjacent addresses with constant stride addressing. Example 700 includes vector register 710, denoted as VRF 1. Continuing with the example from FIG. 6, vector register 710 is 512 bits in length, and comprises 8 vector elements, where each vector element has a width of 64 bits (8 bytes). Vector register 710 includes a group of vector elements 712, starting from vector element 0 at 760, and continuing to vector element 7, as indicated at 767. In embodiments, when constant stride mode is in use, detecting that the memory addresses corresponding to the vector elements comprises contiguous memory locations includes determining if the element width is equal to the constant stride value. In one or more embodiments, this can include using a compare instruction to compare the element width value 720 with a constant stride value in general-purpose register 730, denoted as GPR 2. In embodiments, the element width value 720 can be obtained as an operand from a vector scatter or vector gather instruction. The element width value 720 can be compared with the value in general-purpose register 730, denoted as GPR 2, using compare circuitry. The compare circuitry can indicate equality or inequality between the element width value 720 and the constant stride value stored in general-purpose register 730. In embodiments, the processor executes logic that subtracts the value in general-purpose register 730 from the element width value 720. This subtraction logic can set or update various condition codes or status flags, which indicate the result of the comparison. If the comparison indicates that the element width value 720 is equal to the constant stride value in the general-purpose register 730, denoted as GPR 2, then an adjacent address condition is asserted, as shown at 740, and accelerated vector scatter and vector gather operations can be used. If instead the comparison indicates that the element width value 720 is not equal to the constant stride value, then conventional vector gather and/or vector scatter operations are used. In embodiments, the vector memory instruction includes a constant stride addressing mode. In embodiments, the detecting further comprises reading a constant stride value from a general-purpose register (GPR) within a general-purpose register file.

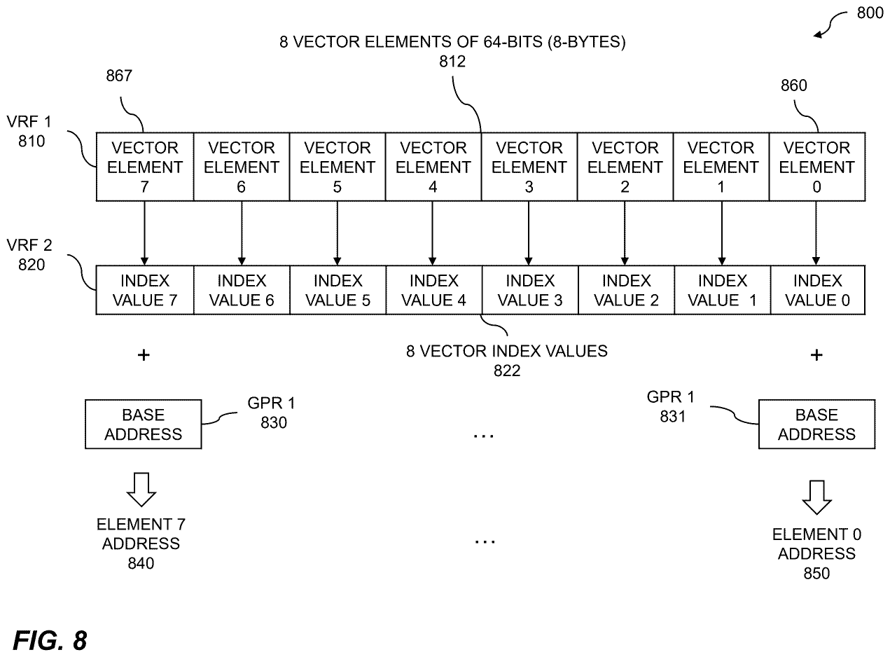

FIG. 8 is an example of an indexed stride addressing mode. The example 800 shows a first vector register 810, denoted as VRF 1, a second vector register 820, denoted as VRF 2, and a first general-purpose register 830, denoted as GPR 1. As shown in the example, the length of vector register 810 is 8, as indicated by the group of vector elements 812, starting from vector element 0 at 860, and continuing to vector element 7, as indicated at 867. In the example 800, each vector element is 64 bits, and with eight elements, the length for vector register VRF 1 is 512 bits. Each vector element from the group of vector elements has a corresponding vector index value stored as an element in second vector register 820, with the group of vector index values within vector register 820 indicated as 822. In some embodiments, vector register 810 and vector register 820 are of equal length. In some embodiments, vector register 810 is longer than vector register 820. In embodiments, the detecting further comprises reading, for each vector element within the first vector register, an index value, wherein each index value is stored in a second vector register. In the example shown in diagram 800, each vector element in vector register 810 is eight bytes. Vector register 820 stores the index value of the corresponding register elements of vector register 810. The corresponding index value for each vector element, along with a base address, describes the memory location of the vector element. As shown in FIG. 8, element 0 address 850 is based on index value 0 in vector register 820, and the base address stored in GPR 1 831. Similarly, element 7 address 840 is based on index value 7 in vector register 820, and the base address stored in GPR 1 830. The element addresses for elements 1-6 are computed in a similar manner. However, for the sake of clarity, other element addresses (for elements 1-6) are not shown in FIG. 8.

Depending on the memory configuration, it may require fewer bits to store the index value than to store the vector element itself. In some embodiments, the vector register 820 may use 32 bits to store the vector index values. Thus, in some embodiments, the length of vector register 810 is 512 bits (8*64) while the length of vector register 820 is 256 bits (8*32). In this way, disclosed embodiments can conserve gates on an integrated circuit. This can provide several advantages, particularly in terms of reducing complexity, improving performance, and conserving resources. A reduced gate count corresponds to lower power consumption. Each gate in an IC consumes power, and by reducing the number of gates, overall power requirements of the circuit can be reduced, which is especially important for battery-powered devices and energy-efficient applications. Additionally, the reduced gate count can result in shorter signal propagation paths within the IC, resulting in reduced propagation delay. This can enable improved speed and lower latency, which can be important in high-performance computing and real-time systems. Furthermore, reducing the number of gates can lead to cost savings in terms of manufacturing, as it simplifies the design and layout of the IC. Fewer gates may require less silicon area and can lead to smaller die sizes, which reduces production costs.

To compute address locations for individual vector elements, a base address is obtained from general-purpose register 830. Embodiments can include accessing a general-purpose register, wherein the general-purpose register includes a base address for the single memory access. The address location for each vector element is computed by adding the base address to the product of the vector element width times the vector element index. In embodiments, this computation can be computed concurrently for each vector element within one clock cycle. The computation is part of the determining if the memory for each of the vector elements is arranged contiguously. In response to detecting a contiguous memory condition, disclosed embodiments automatically use accelerated vector gather and/or vector scatter operations which can complete in one clock cycle, thereby improving overall performance with vector operations.

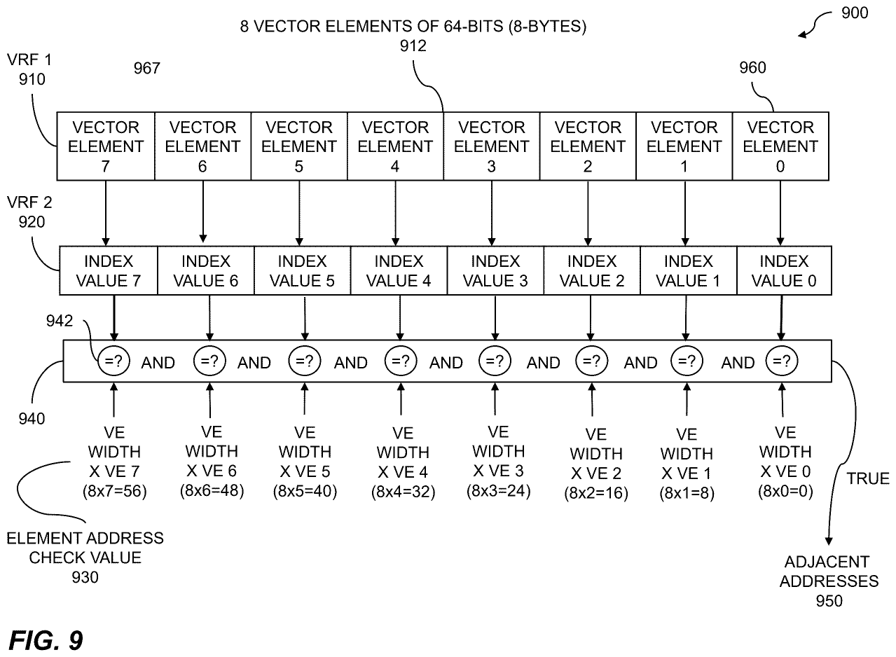

FIG. 9 is an example of adjacent addresses with indexed stride addressing. The example 900 includes vector register 910, denoted as VRF 1. Continuing with the example from FIG. 8, vector register 910 is 512 bits in length, and comprises eight vector elements, where each vector element has a width of 64 bits (8 bytes). Vector register 910 includes a group of vector elements 912, starting from vector element 0 at 960, and continuing to vector element 7, as indicated at 967. To detect a contiguous memory condition, an element address check value 930 is computed for each vector element. This is accomplished by computing a product of the vector element width and the corresponding vector element index value that is stored in vector register 920. In one or more embodiments, dedicated hardware for multiplication, such as multiplier units that are capable of performing multiple multiplication operations in parallel, are used for computing multiple element address check values in parallel.

As an example, vector element 0, indicated at 960, is multiplied by the vector element width, which is eight bytes in the example depicted in FIG. 9, resulting in an address check value of 0. For vector element 1, the computing of the element address check value includes computing the product 8*1 to result in an element address check value of 8, and for vector element 2, the computing of the element address check value includes computing the product 8*2 to result in an element address check value of 16, and so on. More generally, for indexed stride, the address element check value is of the form C=W*Vi, where C is the element address check value, W is the vector element width (e.g., in bytes), and Vi is the vector element index. Embodiments can include calculating, for each vector element within the first vector register, an element address check value, wherein each element address check value comprises a vector element width multiplied by a vector element number. In the example shown in FIG. 9, each vector element from the group of vector elements has a corresponding vector index value stored as an element in second vector register 920. In some embodiments, vector register 910 and vector register 920 are of equal length. In some embodiments, vector register 910 is longer than vector register 920, as similarly to a described in FIG. 8. In embodiments, the index value in vector register 920 is compared with the element address check value 930. In embodiments, the element address check values 930 can be stored in another vector register for efficient comparison. Embodiments can include comparing, for each vector element within the first vector register, the index value to the element address check value that was calculated. As shown in the example 900, a multi-input comparison 940 includes compare elements, shown generally at 942, for each vector element in the vector register 910. If each index value in vector register 920 equals the corresponding element address check value, then an adjacent address condition is asserted, as shown at 950, and accelerated vector scatter and vector gather operations can be used. If instead, the comparison indicates that at least one element address check value 930 is not equal to the corresponding index value in vector register 920, then conventional vector gather and/or vector scatter operations are used. As an example, if vector index value 4, within vector register 920 has a value of 32, and the vector element width (obtained via the vector instruction or a general-purpose register) is 8, then the vector element number (4 in this example) multiplied by the vector element width (8 in this example) equals 32, matching the value stored in vector index value 4 in vector register 920. If this condition applies to all vector index values stored in vector register 920, then a contiguous memory condition is detected, and accelerated vector scatter/gather operations can be used, improving overall processer performance with vector operations. In embodiments, the vector memory instruction includes an indexed stride addressing mode. In embodiments, each index value is equal to each element address check value for every vector element within the first vector register.

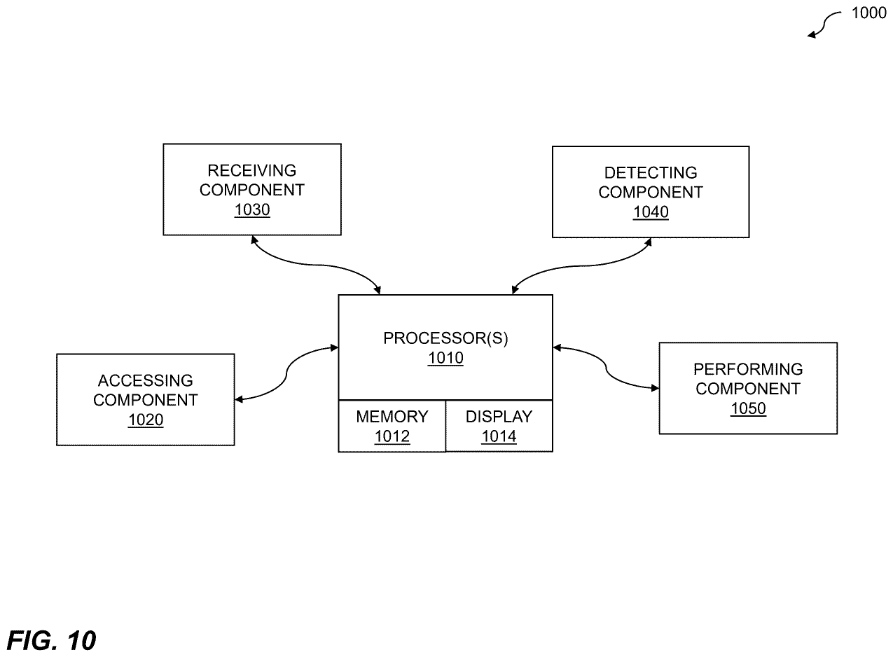

FIG. 10 is a system diagram for vector scatter and gather with single memory access. The system 1000 can include instructions and/or functions for design and implementation of integrated circuits that support sharing data, including sharing vector data to/from memory via scatter and gather operations. The system 1000 can include instructions and/or functions for generation and/or manipulation of design data such as hardware description language (HDL) constructs for specifying structure and operation of an integrated circuit. The system 1000 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 1000 can include one or more processors 1010. The processors can include standalone processors within integrated circuits or chips, processor cores in FPGAs or ASICs, and so on. The one or more processors 1010 are coupled to a memory 1012, which stores operations. The memory can include one or more of local memory, cache memory, system memory, etc. The system 1000 can further include a display 1014 coupled to the one or more processors 1010. The display 1014 can be used for displaying data, instructions, operations, and the like. The operations can include instructions and functions for implementation of integrated circuits, including processor cores. In embodiments, the processor cores can include RISC-V™ processor cores, ARM processor cores, or other suitable types of processor cores.

The system 1000 can include an accessing component 1020. The accessing component 1020 can include functions and instructions for accessing a processor core, wherein the processor core is coupled to a memory hierarchy, wherein the processor core includes one or more vector execution units (VUs) and one or more load store units (LSUs), wherein the processor core includes a vector register file (VRF), wherein the VRF includes a plurality of vector registers, and wherein each vector register in the plurality of vector registers comprises a plurality of vector elements. The processor core can include a RISC-V core, ARM core, and/or other suitable type of core. In embodiments, the LSUs handle load and store instructions that enable the movement of data between the processor's registers and memory, such as RAM. In embodiments, the LSUs perform steps including, but not limited to, memory address calculation, data alignment, load-store queue management, memory ordering, data forwarding, and/or other memory-related functions. The LSUs interface with one or more VUs. Each VU includes a set of vector registers which store the data elements to be processed. These registers can be larger than the general-purpose registers in the processor to accommodate multiple vector elements per vector. The VUs can perform operations using vector instructions. The vector instructions can include addition, subtraction, multiplication, division, and various mathematical and logical operations. In embodiments, the vector instructions can operate on the entire vector or with specific lanes (subsets of the vector) simultaneously.

The system 1000 can include a receiving component 1030. The receiving component 1030 can include functions and instructions for receiving, by an LSU within the one or more LSUs, a vector memory instruction, wherein the vector memory instruction includes a first vector register, a plurality of vector element memory operations, and a plurality of memory addresses, and wherein each vector element within the first vector register is associated with a memory operation in the plurality of vector element memory operations and a memory address in the plurality of memory addresses. Elements within a vector can represent various types of data, and their interpretation largely depends on the context and the specific application. Vectors, in the context of linear algebra, represent ordered collections of elements. In computer graphics and image processing applications, the elements can represent color values, transparency values, luminance values, and so on. In machine learning, the vectors can represent feature vectors, where each element of the vector corresponds to a feature or attribute of an object. In chemistry and drug discovery, vectors can represent chemical compounds, with each element corresponding to the presence or quantity of specific atoms or functional groups. In another example, vectors are used in environmental monitoring to represent data related to weather conditions, air quality, or geological measurements, with each element representing a specific parameter. Regardless of the type of data being represented, disclosed embodiments enable faster processing of vector-based data, making disclosed embodiments useful for a wide variety of applications.

The system 1000 can include a detecting component 1040. The detecting component 1040 can include functions and instructions for detecting, by the LSU, that the plurality of memory addresses comprises contiguous memory locations within the memory hierarchy. The detecting can include ensuring that there are no gaps between adjacent vector elements in memory. With contiguous memory, disclosed embodiments can accomplish vector scatter and vector gather operations in a shorter time period. In one or more embodiments, the vector scatter and vector gather operations are accomplished within one clock cycle.

The system 1000 can include a performing component 1050. The performing component 1050 can include functions and instructions for performing a single memory access by the LSU, wherein the single memory access satisfies each memory operation for each vector element within the vector register file. Thus, in response to detecting a contiguous memory condition, disclosed embodiments can utilize accelerated vector gather and vector scatter operations that operate on a contiguous memory region in a single clock cycle in order to load or store vector elements. The reduced time required for loading and storing vector data can translate into overall performance improvements for execution of computing tasks that include vector instructions.

The system 1000 can include a computer program product embodied in a non-transitory computer readable medium for sharing data, the computer program product comprising code which causes one or more processors to generate semiconductor logic for: accessing a processor core, wherein the processor core is coupled to a memory hierarchy, wherein the processor core includes one or more vector execution units (VUs) and one or more load store units (LSUs), wherein the processor core includes a vector register file (VRF), wherein the VRF includes a plurality of vector registers, and wherein each vector register in the plurality of vector registers comprises a plurality of vector elements; receiving, by an LSU within the one or more LSUs, a vector memory instruction, wherein the vector memory instruction includes a first vector register, a plurality of vector element memory operations, and a plurality of memory addresses, and wherein each vector element within the first vector register is associated with a memory operation in the plurality of vector element memory operations and a memory address in the plurality of memory addresses; detecting, by the LSU, that the plurality of memory addresses comprises contiguous memory locations within the memory hierarchy; and performing a single memory access, by the LSU, wherein the single memory access satisfies each memory operation for each vector element within the vector register file.

The system 1000 can include a computer system for sharing data comprising: a memory which stores instructions; one or more processors coupled to the memory wherein the one or more processors, when executing the instructions which are stored, are configured to: access a processor core, wherein the processor core is coupled to a memory hierarchy, wherein the processor core includes one or more vector execution units (VUs) and one or more load store units (LSUs), wherein the processor core includes a vector register file (VRF), wherein the VRF includes a plurality of vector registers, and wherein each vector register in the plurality of vector registers comprises a plurality of vector elements; receive, by an LSU within the one or more LSUs, a vector memory instruction, wherein the vector memory instruction includes a first vector register, a plurality of vector element memory operations, and a plurality of memory addresses, and wherein each vector element within the first vector register is associated with a memory operation in the plurality of vector element memory operations and a memory address in the plurality of memory addresses; detect, by the LSU, that the plurality of memory addresses comprises contiguous memory locations within the memory hierarchy; and perform a single memory access, by the LSU, wherein the single memory access satisfies each memory operation for each vector element within the vector register file.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods (processor-implemented methods) may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for sharing data comprising:
accessing a processor core, wherein the processor core is coupled to a memory hierarchy, wherein the processor core includes one or more vector execution units (VUs) and one or more load store units (LSUs), wherein the processor core includes a vector register file (VRF), wherein the VRF includes a plurality of vector registers, and wherein each vector register in the plurality of vector registers comprises a plurality of vector elements;
receiving, by an LSU within the one or more LSUs, a vector memory instruction, wherein the vector memory instruction includes a first vector register, a plurality of vector element memory operations, and a plurality of memory addresses, and wherein each vector element within the first vector register is associated with a memory operation in the plurality of vector element memory operations and a memory address in the plurality of memory addresses;
detecting, by the LSU, that the plurality of memory addresses comprises contiguous memory locations within the memory hierarchy; and
performing a single memory access, by the LSU, wherein the single memory access satisfies each memory operation for each vector element within the vector register file.

2. The method of claim 1 wherein the vector memory instruction includes a constant stride addressing mode.

3. The method of claim 2 wherein the detecting further comprises reading a constant stride value from a general-purpose register (GPR) within a general-purpose register file.

4. The method of claim 3 further comprising comparing the constant stride value with a vector element width.

5. The method of claim 4 wherein the constant stride value is equal to the vector element width.

6. The method of claim 1 wherein the vector memory instruction includes an indexed stride addressing mode.

7. The method of claim 6 wherein the detecting further comprises reading, for each vector element within the first vector register, an index value, wherein each index value is stored in a second vector register.

8. The method of claim 7 further comprising calculating, for each vector element within the first vector register, an element address check value, wherein each element address check value comprises a vector element width multiplied by a vector element number.

9. The method of claim 8 further comprising comparing, for each vector element within the first vector register, the index value to the element address check value that was calculated.

10. The method of claim 9 wherein each index value is equal to each element address check value for every vector element within the first vector register.

11. The method of claim 2 wherein the performing comprises accessing a general-purpose register, wherein the general-purpose register includes a base address for the single memory access.

12. The method of claim 2 further comprising defining a vector element width.

13. The method of claim 12 wherein the defining is accomplished by a control register.

14. The method of claim 12 wherein the defining is accomplished by the vector memory instruction.

15. The method of claim 12 wherein the plurality of vector elements within the first vector register comprises a number of vector elements equal to dividing a vector length by the vector element width.

16. The method of claim 15 wherein the plurality of vector elements within the first vector register comprises 8 bits, 16 bits, 32 bits, or 64 bits.

17. The method of claim 1 wherein the vector memory instruction is a vector gather instruction.

18. The method of claim 1 wherein the vector memory instruction is a vector scatter instruction.

19. The method of claim 1 wherein the first vector register comprises 64 bits, 128 bits, 256 bits, or 512 bits.

20. The method of claim 1 wherein the single memory access comprises 64 bits, 128 bits, 256 bits, or 512 bits.

21. A computer program product embodied in a non-transitory computer readable medium for sharing data, the computer program product comprising code which causes one or more processors to generate semiconductor logic for:
accessing a processor core, wherein the processor core is coupled to a memory hierarchy, wherein the processor core includes one or more vector execution units (VUs) and one or more load store units (LSUs), wherein the processor core includes a vector register file (VRF), wherein the VRF includes a plurality of vector registers, and wherein each vector register in the plurality of vector registers comprises a plurality of vector elements;
receiving, by an LSU within the one or more LSUs, a vector memory instruction, wherein the vector memory instruction includes a first vector register, a plurality of vector element memory operations, and a plurality of memory addresses, and wherein each vector element within the first vector register is associated with a memory operation in the plurality of vector element memory operations and a memory address in the plurality of memory addresses;
detecting, by the LSU, that the plurality of memory addresses comprises contiguous memory locations within the memory hierarchy; and
performing a single memory access, by the LSU, wherein the single memory access satisfies each memory operation for each vector element within the vector register file.

22. A computer system for sharing data comprising:
a memory which stores instructions;
one or more processors coupled to the memory wherein the one or more processors, when executing the instructions which are stored, are configured to:
access a processor core, wherein the processor core is coupled to a memory hierarchy, wherein the processor core includes one or more vector execution units (VUs) and one or more load store units (LSUs), wherein the processor core includes a vector register file (VRF), wherein the VRF includes a plurality of vector registers, and wherein each vector register in the plurality of vector registers comprises a plurality of vector elements;
receive, by an LSU within the one or more LSUs, a vector memory instruction, wherein the vector memory instruction includes a first vector register, a plurality of vector element memory operations, and a plurality of memory addresses, and wherein each vector element within the first vector register is associated with a memory operation in the plurality of vector element memory operations and a memory address in the plurality of memory addresses;
detect, by the LSU, that the plurality of memory addresses comprises contiguous memory locations within the memory hierarchy; and
perform a single memory access, by the LSU, wherein the single memory access satisfies each memory operation for each vector element within the vector register file.
